(19) United States
(12) Patent Application Publication
(10) Pub. No.: US 2007/0157854 A1
(43) Pub. Date: Jul. 12, 2007

(54) Composite materials formed of at least partially cured cement-containing particles dispersed through polymeric matrix, applications using same, and methods of making

(75) Inventors: Stacey Roberts, Poulsbo, WA (US); Stephen D. McFadden, Kingston, WA (US)

Correspondence Address: Marcus Simon, Esq.;DORSEY & WHITNEY LLP, Suite 3400, 1420 Fifth Avenue, Seattle, WA, 98101, US

(73) Assignee: Shear Tech, Inc.

(21) Appl. No.: 11/331,892

(22) Filed: Jan. 12, 2006

(51) Int. Cl. C04B 14/00; C04B 24/00

(52) U.S. Cl. 106/731

(57) ABSTRACT

Composite materials including at least partially cured cement-containing particles dispersed through a polymeric matrix and applications utilizing such composite materials such as a floor tile, decking profile, roof profile, stair tread, railings, siding, and interior and exterior trim. Methods of fabricating the composite materials and products are also disclosed.

### TECHNICAL FIELD

This invention generally relates to composite materials including at least partially cured cement-containing particles dispersed through a polymeric matrix and applications thereof.

### BACKGROUND OF THE INVENTION

The exterior of houses and other types of buildings are commonly covered with siding materials that protect the internal structure from external environmental elements. Siding may be made from a variety of materials, including wood, concrete, brick, aluminum, stucco, wood composites, and cement/cellulose composites. Wood siding is popular, but it is costly, flammable, subject to infestation, subject to cracking, and comes from a diminishing resource. Aluminum is also popular, but it is easily deformed, subject to expanding/contracting, and relatively expensive. Brick and stucco siding are popular in certain regions of the country, but they are costly and labor-intensive to install.

Fiber-cement siding offers several advantages compared to other types of siding. Fiber-cement siding is made from a mixture of cement, silica sand, and cellulose fibers. The fiber-cement siding mixture is pressed and then cured to form planks, panels and boards of finished cement siding. Fiber-cement siding is advantageous because it is non-flammable, weatherproof, not subject to rotting or infestation, and relatively inexpensive to manufacture. Fiber-cement siding is also advantageous because it may be formed with simulated wood grains or other designs that give the appearance of a natural product.

Fiber-cement siding products can also be painted like wood, but they are not made from a valuable natural resource. Therefore, many contractors and manufactured builders are switching to fiber-cement siding products from wood, composites, aluminum, plastic and bricks. The increased use of fiber-cement siding may help reduce logging in old growth forests in Washington, Oregon, California, and Alaska. Thus, fiber-cement siding is becoming an increasingly popular siding material in many areas of the country.

The increasing use of fiber-cement siding has resulted in a tremendous waste problem associated with processing fiber-cement materials. During processing of fiber-cement siding, fiber-cement waste is generated that is currently disposed in landfills. The largest supplier of fiber-cement siding, the James Hardie Corporation, generates approximately 140,000 tons of fiber-cement waste per year from processing fiber-cement siding. This large amount of fiber-cement waste affects the landfills in nine states.

One solution to this problem has been to try reincorporating the fiber-cement waste back into a fiber-cement product. However, the resulting fiber-cement products that have included cured recycled fiber-cement have suffered from poor mechanical strength.

Accordingly, there is still a tremendous need for finding an economic and engineering useful manner in which to reclaim the fiber-cement waste generated during processing fiber-cement siding and other products.

### SUMMARY OF THE INVENTION

The invention is directed to composite materials including at least partially cured cement-containing particles dispersed through a matrix material, applications utilizing such composite materials, and methods of fabrication. In one aspect of the invention, a composite material includes a polymeric matrix and a plurality of at least partially cured cement-containing particles dispersed therethrough.

Another aspect of the invention is directed to a building product. The building product includes a member such as a floor tile, decking piece, roofing shingle, stair tread, railings, siding, interior trim, exterior trim, among others. The member is formed of a composite material that includes a polymeric matrix and a plurality of at least partially cured cement-containing particles dispersed therethrough.

Yet another aspect of the invention is directed to a method of fabricating a composite material. The method includes mixing a plurality of at least partially cured cement-containing particles with a polymeric binder material and curing the polymeric binder material.

### BRIEF DESCRIPTION OF THE DRAWINGS

FIG. 1 is schematic cross-sectional view of a composite material in accordance with one embodiment of the invention.

### DETAILED DESCRIPTION OF THE EMBODIMENTS

The invention is directed to composite materials including cured or at least partially cured cement-containing particles dispersed through a matrix material, applications utilizing such composite materials, and methods of fabrication. By dispersing particles formed from fiber-cement waste products or concrete waste products through a matrix material, composite materials may be formed that have desirable engineering properties and provide a solution to the increasing problem of disposal of cement waste products.

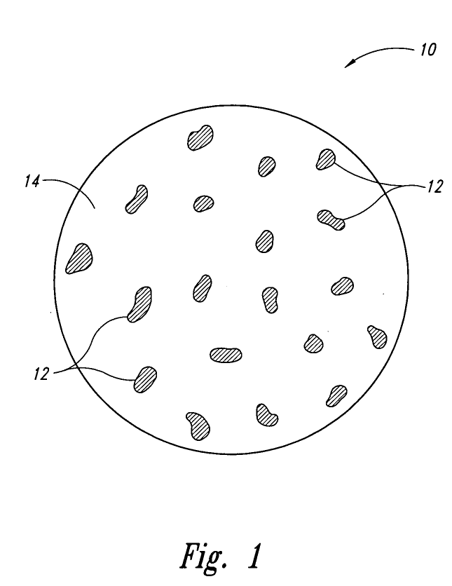

FIG. 1 is a schematic cross-sectional view of a composite material 10 according to one embodiment of the invention. The composite material 10 includes a plurality of cured or at least partially cured cement-containing particles 12 dispersed through and embedded in a polymeric matrix 14. In various embodiments, the cement-containing particles 12 are formed of fiber-cement particles ground from fiber-cement waste products, concrete cement particles ground from concrete products, or combinations thereof. Fiber-cement particles include cement, cellulose fibers, and silica sand.

The polymeric matrix 14 binds the cement-containing particles 12 together to form the composite material 10 and may be selected from a variety of different materials. Examples of suitable materials for the polymeric matrix 14 includes, but is not limited to, thermoplastic and thermosetting polymeric materials, such as, high density polyethylene (HDPE), polyvinyl chloride (PVC), nylon, epoxies, fiber-glass, acrylonitrile styrene acrylate (ASA), combinations thereof, or another suitable reinforced or non-reinforced polymeric material.

According to various embodiments, the polymeric matrix 14 may include a number of different functional additives. In one embodiment, the additive may be an ultraviolet (UV) inhibitor that helps prevent the polymeric matrix 14 from deteriorating when exposed to UV radiation commonly experienced in an outdoor environment due to exposure to the sun. In another embodiment, the additive is a biocide that helps prevent mold and/or mildew growth on or in the composite material 10. In yet another embodiment, the additive is a dye that is selected to impart a desired color to the composite material 10. Of course, one or more of the above additives may be used in combination with each other to control the physical and chemical characteristics of the polymeric matrix 14. In some embodiments, in addition or as an alternative to the above functional additives, the composite material 10 may include fine sawdust particles (i.e., wood particles) dispersed through the polymeric matrix 14 to selectively tailor certain characteristics of the composite material 10, such as formability and other mechanical properties (e.g., strength).

The composite material 10 may be used in a variety of different applications for building products. In various embodiments, the composite material 10 may be formed into a floor tile, decking piece, roof shingle, stair tread, railings, siding, interior trim, and exterior trim. In one particular embodiment where the composite material 10 is fabricated into a decking piece, such as a beam, it may be used to replace currently available composite wood products formed of a polymeric matrix and wood particles. A decking piece or another building product formed of the composite material 10 having the cement-containing particles 12 dispersed through the polymeric matrix 14 is more fire resistant, and mold and mildew resistant that conventional composite wood products or pressure treated wood. In such an embodiment, it may be desirable to also distribute sawdust particles, in addition, to the cement-containing particles 12 to tailor certain characteristics of the composite material 10. Additionally, unlike conventional pressure treated wood, which typically uses arsenic for the pressure treating, the composite material 10 is less harmful to the environment since such chemical treatments do not have to be utilized.

One composition for the composite material 10 suitable for use as a decking piece or another building product application is about 30 to about 35 weight percent HDPE for the polymeric matrix 14 and the balance being ground fiber-cement particles having a size about 200 to about 360 microns (i.e., about 40 through about 60 mesh) for the cement-containing particles 12 and, if present, small amounts of additives.

Products may be fabricated from the composite material 10 using a variety of techniques, such as extruding, injection molding, and casting. In one embodiment of a method of extruding the composite material 10, the cured or at least partially cured cement-containing particles 12 are ground to about 200 to about 360 microns using a hammer mill or another suitable milling apparatus. The cement-containing particles 12 may be ground from concrete or fiber-cement waste generated during fabrication of other products such as fiber-cement siding. The ground cement-containing particles 12 are mixed with a powdered polymeric binder, which may be formed of any of the above polymeric materials suitable for the polymeric matrix 14. The mixture of cement-containing particles 12 and polymeric binder are heated and extruded through a die to a desired geometric configuration. The extruded product is cooled by spraying chilled water thereon to cure the polymeric matrix 14. The cooled extrusion may be cut to a selected size.

In one embodiment of a method of injection molding the composite material 10, the cured or at least partially cured cement-containing particles 12 are ground as previously mentioned and mixed with a powdered polymeric binder that may be formed of any of the above polymeric materials suitable for the polymeric matrix 14. The mixture of cement-containing particles 12 and the polymeric binder is heated and injected into a die of an injection molding apparatus to form a molded product having a desired geometric configuration. The polymeric matrix 14 is allowed to cool to cure.

In one embodiment of a method of casting the composite material 10, the cured or at least partially cured cement-containing particles 12 are ground as previously mentioned and mixed with a powdered polymeric binder that may be formed of any of the above polymeric materials suitable for the polymeric matrix 14. The mixture of cement-containing particles 12 and the polymeric binder may be heated to a sufficient temperature to cause the binder to flow and the mixture is poured into a die. The mixture is allowed to cure to form a product having a desired shape.

Although the invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

What is claimed is:

1. A composite material, comprising:
a polymeric matrix; and
a plurality of at least partially cured cement-containing particles dispersed through the polymeric matrix.

2. The composite material of claim 1 wherein at least some of the at least partially cured cement-containing particles comprise cured fiber-cement particles.

3. The composite material of claim 1 wherein at least some of the at least partially cured cement-containing particles comprise concrete particles.

4. The composite material of claim 1 wherein the plurality of at least partially cured cement-containing particles comprises cured fiber-cement particles and concrete particles.

5. The composite material of claim 1, further comprising wood particles dispersed through the polymeric matrix.

6. The composite material of claim 1 wherein the polymeric matrix comprises a reinforced polymeric material.

7. The composite material of claim 1 wherein the polymeric matrix comprises a non-reinforced polymeric material.

8. The composite material of claim 1 wherein the polymeric matrix is selected from the group consisting of high density polyethylene (HDPE), polyvinyl chloride (PVC), nylon, acrylonitrile styrene acrylate (ASA), fiber-glass, and an epoxy.

9. The composite material of claim 1 wherein the polymeric matrix comprises an additive selected from the group consisting of a UV inhibitor, a biocide, a dye, and combinations thereof.

10. The composite material of claim 1 wherein the polymeric matrix is about 30 to about 35 weight percent of the composite material.

11. A building product, comprising:
a member formed of a composite material, the composite material comprising:
a polymeric matrix; and
a plurality of at least partially cured cement-containing particles dispersed through the polymeric matrix.

12. The building product of claim 11 wherein at least some of the at least partially cured cement-containing particles comprise cured fiber-cement particles.

13. The building product of claim 11 wherein at least some of the at least partially cured cement-containing particles comprise concrete particles.

14. The building product of claim 11 wherein the plurality of at least partially cured cement-containing particles comprises cured fiber-cement particles and concrete particles.

15. The building product of claim 11, further comprising wood particles dispersed through the polymeric matrix.

16. The building product of claim 11 wherein the polymeric matrix comprises a reinforced polymeric material.

17. The building product of claim 11 wherein the polymeric matrix comprises a non-reinforced polymeric material.

18. The building product of claim 11 wherein the polymeric matrix is selected from the group consisting of high density polyethylene (HDPE), polyvinyl chloride (PVC), nylon, acrylonitrile styrene acrylate (ASA), fiber-glass, and an epoxy.

19. The building product of claim 11 wherein the polymeric matrix comprises an additive selected from the group consisting of a UV inhibitor, a biocide, a dye, and combinations thereof.

20. The building product of claim 11 wherein the polymeric matrix is about 30 to about 35 weight percent of the composite material

21. The building product of claim 11 wherein the member is configured as a floor tile.

22. The building product of claim 11 wherein the member is configured as a decking piece.

23. The building product of claim 11 wherein the member is configured as a stair tread.

24. The building product of claim 11 wherein the member is configured as a railing.

25. The building product of claim 11 wherein the member is configured as a siding piece.

26. The building product of claim 11 wherein the member is configured as a roofing shingle.

27. The building product of claim 11 wherein the member is configured as a trim piece.

28. The building product of claim 11 wherein the member comprises an extruded member.

29. The building product of claim 11 wherein the member comprises a molded member.

30. The building product of claim 11 wherein the member comprises a cast member.

31. A method of manufacturing a composite material, comprising:
mixing a polymeric binder material and a plurality of cement-containing particles together; and
curing the polymeric binder material.

32. The method of claim 31 wherein the plurality of at least partially cured cement-containing particles were ground from cement waste product.

33. The method of claim 31, further comprising forming the at least partially cured cement-containing particles by grinding cement waste product.

34. The method of claim 33 wherein the act of forming the at least partially cured cement-containing particles by grinding cement waste product comprises grinding fiber-cement waste product.

35. The method of claim 33 wherein the act of forming the at least partially cured cement-containing particles by grinding cement waste product comprises grinding concrete waste product.

36. The method of claim 31, further comprising extruding the polymeric binder material and the at least partially cured cement-containing particles to form an article.

37. The method of claim 31, further comprising injection molding the polymeric binder material and the at least partially cured cement-containing particles to form an article.

38. The method of claim 31, further comprising casting the polymeric binder and the at least partially cured cement-containing particles to form an article.

39. The method of claim 31, further comprising mixing wood particles with the polymeric binder material and the at least partially cured cement-containing particles.

40. The method of claim 31 wherein the act of curing the polymeric binder material comprises curing the polymeric binder material to form the composite material having a cured polymeric matrix with the plurality of at least partially cured cement-containing particles dispersed therethrough.
